(19) United States
(12) Patent Application Publication
(10) Pub. No.: US 2017/0075573 A1
(43) Pub. Date: Mar. 16, 2017

(54) VSAM ACCESS METHOD SELECTION AND UTILIZATION

(71) Applicant: International Business Machines Corporation, Armonk, NY (US)

(72) Inventors: Preston A. Carpenter, Vail, AZ (US); David C. Reed, Tucson, AZ (US); Esteban Rios, Tucson, AZ (US); Max D. Smith, Tucson, AZ (US)

(73) Assignee: International Business Machines Corporation, Armonk, NY (US)

(21) Appl. No.: 14/855,491

(22) Filed: Sep. 16, 2015

(51) Int. Cl. G06F 3/06

(52) U.S. Cl. CPC G06F 3/061; G06F 3/0653; G06F 3/0634; G06F 3/0667; G06F 3/0673

(57) ABSTRACT

A method for selecting and utilizing an access method for a VSAM data set includes monitoring a VSAM data set utilizing a first access method to access data therein. When performing such monitoring, specific indicators associated with the VSAM data set are observed. These indicators may include, for example, a number of input/output requests to the VSAM data set, a deferred request count against a control interval of the VSAM data set, a number of systems attempting to access the VSAM data set, and a number of reads/writes simultaneously occurring to the VSAM data set. The method analyzes these indicators to determine whether I/O performance of the VSAM data set would be enhanced by switching to a second access method. If the I/O performance would be enhanced, the method may be configured to automatically switch to the second access method. A corresponding system and computer program product are also disclosed.

### BACKGROUND

Field of the Invention

This invention relates to systems and methods for selecting an optimal access method to access VSAM data sets.

Background of the Invention

In the z/OS operating system, VSAM (Virtual Storage Access Method) describes an access method as well as various structures for organizing data. VSAM currently includes four data set organizations, namely key-sequenced data sets, relative record data sets, entry-sequenced data sets, and linear data sets. The first three of these data sets contain records that can be of either fixed or variable length. These records may be organized in fixed-size blocks referred to as control intervals (CIs), and then into larger divisions referred to as control areas (CAs).

When creating data sets, a user may have the option to specify an access method that is used to access the data set. For example, when creating key-sequenced VSAM data sets, the user may specify whether to use a base VSAM access method or an RLS (Record Level Sharing) access method to access the data sets. Ideally, an access method is selected that will yield the best I/O performance. Nevertheless, at the time a data set is created, it may not be obvious to the user what access method would yield the best performance. This unfortunately results in many data sets being configured for access by a first access method when a second access method may have yielded better I/O performance. In other cases, access patterns to a data set may change over time. In such cases, the access method that is optimal may also change over time.

In view of the foregoing, what are needed are systems and methods to select an optimal access method for accessing a data set. Ideally, such systems and methods will allow the access method to be automatically selected and utilized if the access method would yield better I/O performance. Further needed are systems and methods for selecting an optimal access method for a data set at the time the data set is created. Yet further needed are systems and methods to change an access method for a data set when access patterns to the data set change over time.

### SUMMARY

The invention has been developed in response to the present state of the art and, in particular, in response to the problems and needs in the art that have not yet been fully solved by currently available systems and methods. Accordingly, the invention has been developed to provide systems and methods to select and utilize an optimal access method for a VSAM data set. The features and advantages of the invention will become more fully apparent from the following description and appended claims, or may be learned by practice of the invention as set forth hereinafter.

Consistent with the foregoing, a method for selecting and utilizing an access method for a VSAM data set is disclosed herein. In one embodiment, such a method includes monitoring a VSAM data set utilizing a first access method to access data therein. When performing such monitoring, specific indicators associated with the VSAM data set are observed. These indicators may include, for example, a number of input/output requests to the VSAM data set, a deferred request count against a control interval of the VSAM data set, a number of systems attempting to access the VSAM data set, a number of reads/writes simultaneously occurring to the VSAM data set, and/or the like. The method analyzes these indicators to determine whether I/O performance of the VSAM data set would be enhanced by switching to a second access method. If the I/O performance would be enhanced, the method may be configured to automatically switch to the second access method.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network architecture in which a system and method in accordance with the invention may operate;

FIG. 2 is a high-level block diagram showing one embodiment of a storage system that may store VSAM and other data sets;

FIG. 3 is a high-level block diagram showing operation of an access method selection module in accordance with the invention;

FIG. 4 shows one embodiment of a method for selecting an access method for an existing data set; and

FIG. 5 shows one embodiment of a method for selecting an access method for a newly created data set.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

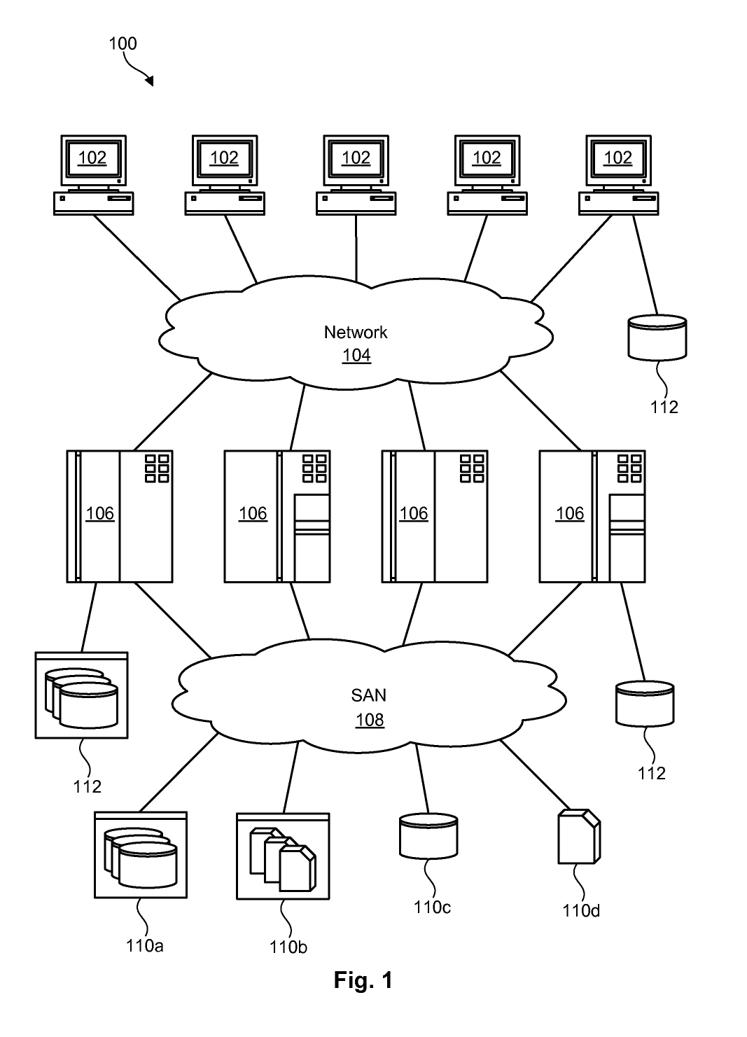

Referring to FIG. 1, one example of a network architecture 100 is illustrated. The network architecture 100 is presented to show one example of an environment where systems and methods in accordance with the invention may be implemented. The network architecture 100 is presented only by way of example and not limitation. Indeed, the systems and methods disclosed herein may be applicable to a wide variety of network architectures, in addition to the network architecture 100 shown.

As shown, the network architecture 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network architecture 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC).

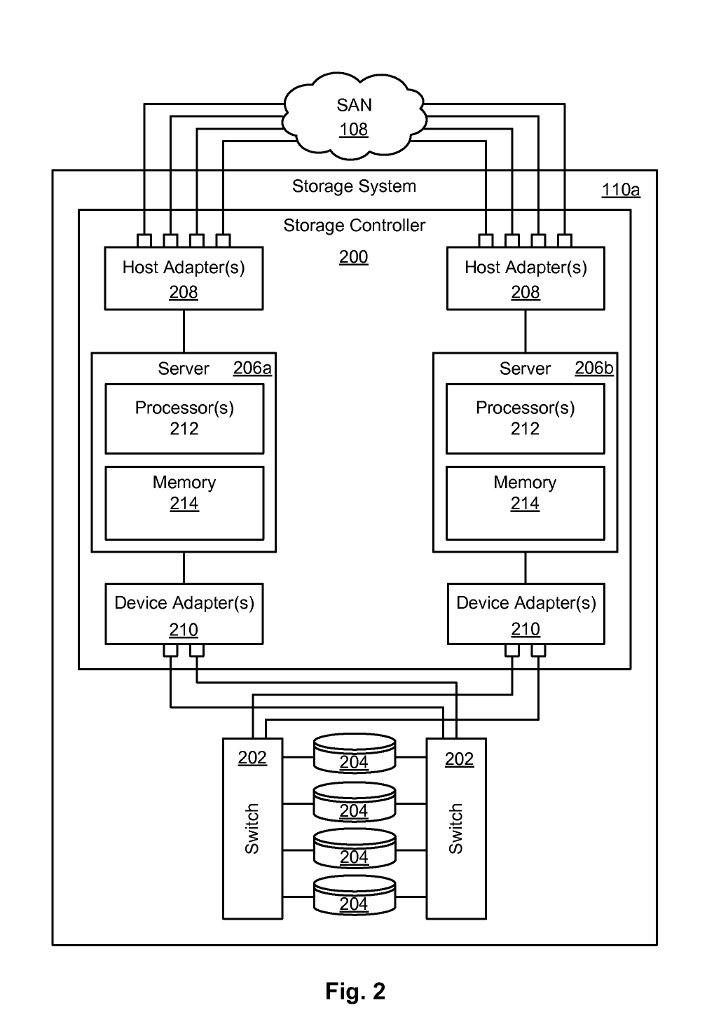

Referring to FIG. 2, one embodiment of a storage system 110a containing an array of hard-disk drives 204 and/or solid-state drives 204 is illustrated. As shown, the storage system 110a includes a storage controller 200, one or more switches 202, and one or more storage devices 204, such as hard disk drives 204 or solid-state drives 204 (such as flash-memory-based drives 204). The storage controller 200 may enable one or more hosts 106 (e.g., open system and/or mainframe servers 106 running operating systems such as MVS, z/OS, or the like) to access data in the one or more storage devices 204.

In selected embodiments, the storage controller 200 includes one or more servers 206. The storage controller 200 may also include host adapters 208 and device adapters 210 to connect the storage controller 200 to host devices 106 and storage devices 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage devices 204. This process may be referred to as a “failover.”

One example of a storage system 110a having an architecture similar to that illustrated in FIG. 2 is the IBM DS8000™ enterprise storage system. The DS8000™ is a high-performance, high-capacity storage controller providing disk storage that is designed to support continuous operations. Nevertheless, the apparatus and methods disclosed herein are not limited to operation with the IBM DS8000™ enterprise storage system 110a, but may operate with any comparable or analogous storage system 110, regardless of the manufacturer, product name, or components or component names associated with the system 110. Furthermore, any storage system that could benefit from one or more embodiments of the invention is deemed to fall within the scope of the invention. Thus, the IBM DS8000™ is presented only by way of example and is not intended to be limiting.

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage devices 204. The servers 206 may host at least one instance of these software modules. These software modules may manage all read and write requests to logical volumes in the storage devices 204.

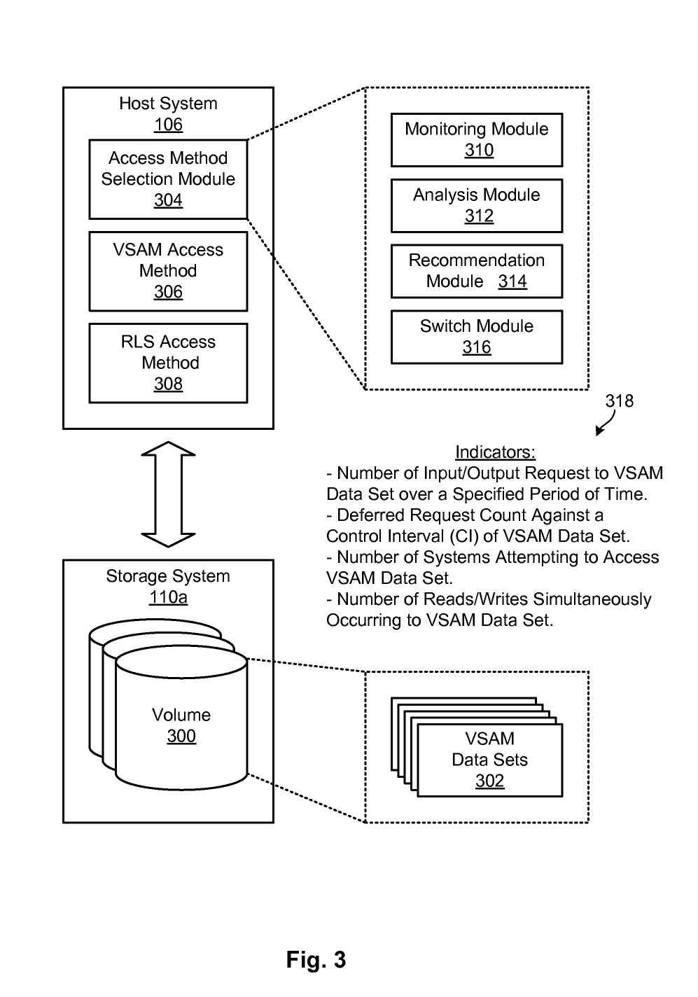

Referring to FIG. 3, in certain embodiments, a storage system 110 may include one or more logical volumes 300, storing one or more VSAM data sets 302. As previously mentioned, when creating VSAM data sets 302, a user may have the option to specify an access method that is used to access the data set. For example, when creating key-sequenced VSAM data sets 302, the user may specify whether to use a base VSAM access method 306 or an RLS (Record Level Sharing) access method 308 to access the data sets 302. Compared to the VSAM access method 306, the RLS access method 308 provides serialization on a smaller level of granularity, but at the expense of more overhead (e.g., additional use of cache, buffer space, locks, etc.). The VSAM access method 306 locks and accesses data at the control interval (CI) level whereas the RLS access method 308 locks and accesses data at the record level. Because a control interval may contain many records, the RLS access method 308 will free up other records in the control interval for access, as opposed to locking the entire control interval. In general, use of the RLS access method 308 may be preferred in situations where there is a significant amount of contention to access records in a VSAM data set 302.

Ideally, an access method 306, 308 will be selected that will yield the best I/O performance. Nevertheless, at the time a data set 302 is created, it may not be obvious to the user which access method 306, 308 would yield the best performance. This unfortunately results in many data sets 302 being configured for access by a first access method 306, 308 when a second access method, 306, 608 may have yielded better I/O performance. In other cases, access patterns to a data set may change over time. In such cases, the access method that is considered optimal for a data set may also change over time.

To ensure that a VSAM data set 302 is accessed using a preferred or optimal access method, an access method selection module 304 in accordance with the invention may be provided. In certain embodiments, the access method selection module 304 may execute on the host system 106 previously discussed. The access method selection module 304 may include various sub-modules to provide various features and functions. For example, as shown, the access method selection module 304 may include one or more of a monitoring module 310, analysis module 312, recommendation module 314, and switch module 316. The modules may be implemented in software, hardware, or a combination thereof.

A monitoring module 310 may be configured to monitor a VSAM data set 302 after it is created and in use. In particular, the monitoring module 310 may be configured to monitor and observe one or more indicators 318 (e.g., historical data) associated with the VSAM data set 302. These indicators may include, for example, a number of input/output requests to the VSAM data set 302 over a specified period of time; a deferred request count against a control interval of the VSAM data set 302; a number of systems (e.g., host systems 106) attempting to access the VSAM data set 302; a number of reads/writes simultaneously occurring to the VSAM data set 302, and/or the like. The significance of these indicators 318 will be discussed in more detail hereafter.

An analysis module 312 may be configured to analyze the indicators 318 to determine whether I/O performance of the VSAM data set 302 would be enhanced by switching to another access method. For example, if historical data indicates that an application using a VSAM data set 302 only performs a single read or write at a time, use of the RLS access method 308 would likely provide no improvement in I/O performance. In fact, use of RLS would likely reduce I/O performance due to the additional overhead involved. By contrast, if a large number of reads/writes simultaneously occur to a VSAM data set 302, then use of the RLS access method 308 would likely improve I/O performance since the RLS access method 308 would lock data at a lower level of granularity, namely at the record level, thereby freeing up records for access by other threads/applications/systems.

Similarly, if a deferred request count against a control interval (CI) of a VSAM data set 302 is high (indicating that applications or systems are frequently being locked out from accessing a control interval of a data set 302), or a number of systems attempting to access a VSAM data set 302 is high, or if a number of input/output requests to a VSAM data set 302 over a specified period of time is high, this may indicate that there is significant contention to access a VSAM data set 302. In such cases, switching to the RLS access method 308 may improve I/O performance. Similarly, in the event the opposite is true for any or all of the above-named indicators 318, thereby indicating reduced contention to access a VSAM data set 302, switching to the VSAM access method 306 (in the event the RLS access method 308 is currently being used) may result in improved I/O performance.

Once the indicators 318 have been analyzed, a recommendation module 314 may, in certain embodiments, make a recommendation to a user. For example, the recommendation module 314 may recommend that a data set 302 be switched from the VSAM access method 306 to the RLS access method 308, or vice versa. In certain embodiments, the recommendation module 314 provides reasons or data why the switch is recommended or shows possible I/O performance improvements that could be achieved by switching. This allows a user to make the decision to switch access methods and may in certain embodiments provide sufficient information so that the user can make an informed decision.

In certain embodiments, the recommendation module 314 makes recommendations on a periodic basis (each day or week, for example). In other embodiments, the recommendation module 314 makes recommendations at or near a time a determination is made that I/O performance may be improved by switching access methods. For example, if conditions change in a way that switching access methods would yield an improvement in I/O performance, the recommendation module 314 may make a recommendation at this time. The recommendation module 314 may communicate recommendations to the user using any suitable technique, including, for example, sending an email or other message, or presenting a recommendation by way of a console associated with the access method selection module 304.

Alternatively, or additionally, a switch module 316 may be provided to automatically switch from one access method to another. For example, a user may be provided an option to automatically switch between access methods when conditions warrant. If I/O performance may be improved by switching to the RLS access method 308 (as determined by the analysis module 312), the switch module 316 may automatically switch to the RLS access method 308. Similarly, if I/O performance may be improved by switching to the VSAM access method 306 (such as if contention to access the data set 302 decreases or RLS resources such as cache, buffer space, locks, etc. become scarce), the switch module 316 may automatically switch to the VSAM access method 306.

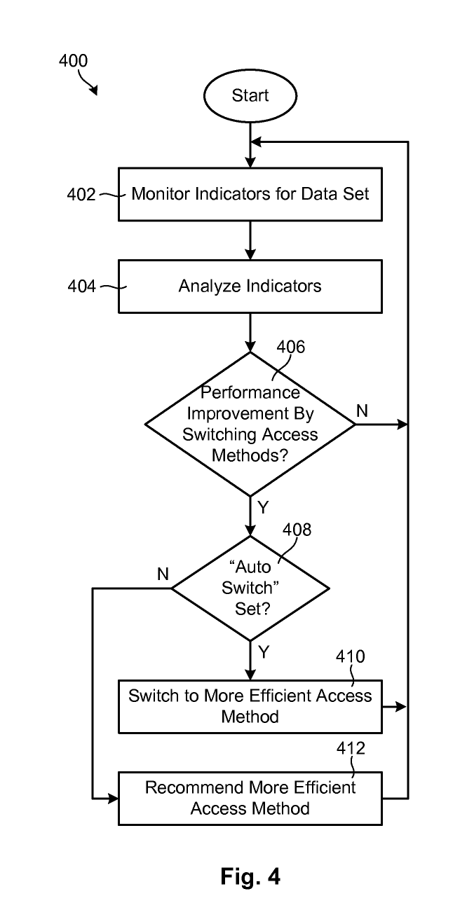

Referring to FIG. 4, one embodiment of a method 400 for selecting an optimal access method for an existing data set 302 is illustrated. Such a method 400 may be executed by the access method selection module 304 previously discussed when selecting an access method for an existing data set 302. As shown, the method 400 initially monitors 402 indicators 318 associated with the data set 302. Monitoring 402 may include monitoring 402 the data set 302 in real time. Monitoring 402 may additionally or alternatively include monitoring 402 the data set 302 in the background as a batch job that analyzes SMF (System Management Facility) records or other historical data.

The method may then analyze 404 the indicators 318. If, at step 406, I/O performance may be improved by switching from one access method to another (such as by switching from the VSAM access method 306 to the RLS access method 308, or vice versa), the method 400 checks 408 whether an “auto switch” option is set. If the “auto switch” option is set, the method 400 automatically switches 410 to the access method that will improve I/O performance. If the “auto switch” option is not set, the method 400 recommends 412 switching to the more efficient access method, thereby allowing a user to decide whether to make the switch.

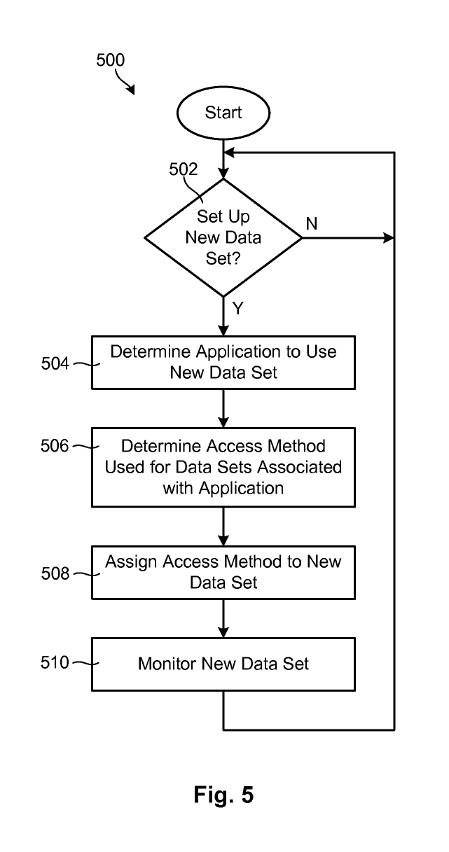

Referring to FIG. 5, one embodiment of a method 500 for selecting an access method for a newly created data set 302 is illustrated. Such a method 500 may, in certain embodiments, also be executed by the access method selection module 304 previously discussed when setting up a new data set 302. As shown, the method 500 initially determines 502 whether a new data set 302 is being set up. If a new data set 302 is being set up, the method 500 determines 504 which application is going to use the data set 302. The method 500 then determines 506 which access method is being used for data sets 302 associated with the application. In certain embodiments, this may be an access method that was previously selected by the access method selection module 304 for other data sets 302 associated with the application based on the analysis of various indicators 318.

Once the method 500 determines 506 which access method is used for data sets 302 associated with the application, the method 500 assumes that the newly created data set 302 will be accessed in much the same manner. As a result, the method 500 assigns 508 the same access method to the newly created data set 302. The method 500 then monitors 510 the new data set 302 as previously discussed. In essence, this step 510 passes control to the method 400 illustrated in FIG. 4 so that it can verify that the correct access method was selected as well as update the access method associated with the data set 302 if and when conditions warrant. The method 500 then returns to the top where it waits 502 for a new data set 302 to be set up.

Although particular reference has been made herein to the VSAM access method 306 and the RLS access method 308, the systems and methods disclosed herein may be equally applicable to other types of access methods. That is, the systems and methods disclosed herein may be used to optimize and switch between other types of access methods, including access methods not specifically addressed herein. Similarly, the systems and methods disclosed herein may be applicable to other types of data sets 302, as opposed to just VSAM data sets 302. That is, the systems and methods disclosed herein may be used to monitor indicators 318 associated with other types of data sets 302 and make recommendations with regard to an optimal access method and/or switch between different access methods.

The disclosed systems and methods make it possible to monitor very large numbers of VSAM data sets at once to better optimize a system setup. Most systems have thousands of different VSAM data sets having I/O driven to and from them everyday. The systems and methods disclosed herein make it possible for all of the data sets on a system to evolve for better performance as I/O driven to the system changes over time.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for selecting and utilizing an access method for a VSAM (Virtual Storage Access Method) data set, the method comprising:
monitoring a VSAM data set utilizing a first access method to access data therein;
observing specific indicators associated with the VSAM data set;
analyzing the indicators to determine whether I/O performance of the VSAM data set would be enhanced by switching to a second access method; and
automatically switching to the second access method in the event the I/O performance would be enhanced.

2. The method of claim 1, wherein the first access method is a base VSAM access method.

3. The method of claim 1, wherein the second access method is an RLS (Record Level Sharing) access method.

4. The method of claim 1, wherein the VSAM data set is a key-sequenced VSAM data set.

5. The method of claim 1, wherein the specific indicators comprise at least one of: a number of input/output requests to the VSAM data set; a deferred request count against a control interval of the VSAM data set; a number of systems attempting to access the VSAM data set; and a number of reads/writes simultaneously occurring to the VSAM data set.

6. The method of claim 1, where monitoring comprises monitoring in real time.

7. The method of claim 1, wherein monitoring comprises monitoring in the background as a batch job that analyzes SMF (System Management Facility) records.

8. A computer program product for selecting and utilizing an access method for a VSAM (Virtual Storage Access Method) data set, the computer program product comprising a computer-readable medium having computer-usable program code embodied therein, the computer-usable program code comprising:
computer-usable program code to monitor a VSAM data set utilizing a first access method to access data therein;
computer-usable program code to observe specific indicators associated with the VSAM data set;
computer-usable program code to analyze the indicators to determine whether I/O performance of the VSAM data set would be enhanced by switching to a second access method; and
computer-usable program code to automatically switch to the second access method in the event the I/O performance would be enhanced.

9. The computer program product of claim 8, wherein the first access method is a base VSAM access method.

10. The computer program product of claim 8, wherein the second access method is an RLS (Record Level Sharing) access method.

11. The computer program product of claim 8, wherein the VSAM data set is a key-sequenced VSAM data set.

12. The computer program product of claim 8, wherein the specific indicators comprise at least one of: a number of input/output requests to the VSAM data set; a deferred request count against a control interval of the VSAM data set; a number of systems attempting to access the VSAM data set; and a number of reads/writes simultaneously occurring to the VSAM data set.

13. The computer program product of claim 8, where monitoring comprises monitoring in real time.

14. The computer program product of claim 8, wherein monitoring comprises monitoring in the background as a batch job that analyzes SMF (System Management Facility) records.

15. A system for selecting and utilizing an access method for a VSAM (Virtual Storage Access Method) data set, the system comprising:
at least one processor;
at least one memory device operably coupled to the at least one processor and storing instructions for execution on the at least one processor, the instructions causing the at least one processor to:
monitor a VSAM data set utilizing a first access method to access data therein;
observe specific indicators associated with the VSAM data set;
analyze the indicators to determine whether I/O performance of the VSAM data set would be enhanced by switching to a second access method; and
automatically switch to the second access method in the event the I/O performance would be enhanced.

16. The system of claim 15, wherein the first access method is a base VSAM access method.

17. The system of claim 15, wherein the second access method is an RLS (Record Level Sharing) access method.

18. The system of claim 15, wherein the VSAM data set is a key-sequenced VSAM data set.

19. The system of claim 15, wherein the specific indicators comprise at least one of: a number of input/output requests to the VSAM data set; a deferred request count against a control interval of the VSAM data set; a number of systems attempting to access the VSAM data set; and a number of reads/writes simultaneously occurring to the VSAM data set.

20. The system of claim 15, where monitoring comprises at least one of: monitoring in real time; and monitoring in the background as a batch job that analyzes SMF (System Management Facility) records.
